(19) United States
(12) Patent Application Publication
(10) Pub. No.: US 2011/0138158 A1
(43) Pub. Date: Jun. 9, 2011

(54) INTEGRATED CIRCUIT

(76) Inventor: Masatomo Mitsuhashi, Osaka (JP)

(21) Appl. No.: 13/056,464

(22) PCT Filed: Jul. 24, 2009
(86) PCT No.: PCT/JP2009/003496

§ 371 Date: Jan. 28, 2011

(30) Foreign Application Priority Data
Jul. 30, 2008 (JP) 2008-196909

(51) Int. Cl. G06F 9/44

(52) U.S. Cl. 712/245; 712/E09.049

(57) ABSTRACT

The present invention allows an integrated circuit to easily control interfaces utilizing new interface types. In order to achieve the above, an ASIC (100) includes: a microprocessor (110) which executes a predetermined instruction code and (an instruction code for a configuration); and a functional block (130) which generates, through an operation reconfiguration, a control signal executing interface control of an external memory (180), the operation configuration being carried out by the microprocessor (110) executing the predetermined instruction code. The functional block (130) generates a predetermined signal pattern by the microprocessor (110) executing a sequence of instructions including the predetermined instruction code.

### TECHNICAL FIELD

The present invention relates to integrated circuits and, in particular, to a circuit system of a control large scale integrated circuit (LSI) forming a storage media, a storage apparatus, and a control apparatus in which a semiconductor memory is used.

### BACKGROUND ART

A flash memory is one of major non-volatile semiconductor memories, and is used in various electronics devices suitable for both consumer devices and industrial devices including cellular phones, digital cameras, and portable music players.

For an efficient use of a flash memory as a storage device, designated LSIs are required to control an interface of the storage device. Among such LSIs, in particular, an application specific integrated circuit (ASIC) is designed and manufactured for a specific purpose.

On the other hand, a field programmable gate array (FPGA) is an LSI including a storage element with an SRAM memory cell structure. The FPGA implements a desired logic operation with logic information and wiring information designed by a user and programmed into the storage element. The FPGA implements a desired circuit operation with the logic information and the wiring information designed by the user and loaded into the storage element which is formed in an SRAM memory cell structure. The FPGA is advantageous to the ASIC in that the FPGA requires a change in specifications and modifications can be made to the FPGA after the designing of the FPGA is completed.

Concurrently, the improvement of semiconductor manufacturing techniques in recent years has significantly increased integration density of flash memories, resulting in the technologic competition among the manufacturers. Consequently, there is an upsurge in interface types to a memory chip. In addition, manufactures sell storage media equipped with a flash memory and utilizing various interfaces.

### CITATION LIST

### Patent Literature

Japanese Unexamined Patent Application Publication No. 03-75911

### SUMMARY OF INVENTION

### Technical Problem

In addition to its excessive development period, the ASIC has the following considerable problems due to finer processes in designing semiconductors in recent years: enormous development expenses over some ten million yen, and the ASIC cannot have the specifications changed without re-designing its once-designed memory interface configurations.

Since there is an upsurge in interface types, manufacturers could suffer a large amount of development expenses and an excessive period if they re-design and develop interfaces just because the market desires such new interface types.

Compared with an interface circuit in which the ASIC is used, concurrently, a memory interface circuit equipped with the FPGA has a lot of drawbacks: several times greater power consumption, lower frequency performance achieved on identical circuits, as well as a higher price per device. In particular, the FPGA is not suitable to a small memory device which has to work on a very tight power condition.

The present invention is conceived in view of the above problems and has as an object to introduce an integrated circuit easily capable of controlling an interface compliant with a new interface type when the integrated circuit employs the new interface type.

### Solution to Problem

In order to solve the above problems, the present invention employs the structures below.

An integrated circuit according to an aspect of the present invention includes: a microprocessor which executes a predetermined instruction code and includes a storage unit and an instruction decoder; an interface unit through which data is transmitted between a memory device which stores digital data and the integrated circuit; and a functional block which generates, through an operation reconfiguration, a predetermined control signal executing interface control of the memory device, the operation reconfiguration being carried out by (i) the microprocessor executing the predetermined instruction code, and (ii) the instruction decoder decoding the predetermined instruction code, wherein the functional block generates a predetermined signal pattern by the microprocessor executing a predetermined sequence of instructions (i) stored in the storage unit, and (ii) including instruction codes having the predetermined instruction code.

In this structure, execution of a sequence of instructions including instruction codes generates a signal pattern. The signal pattern to be generated is a signal pattern to cause the memory device to execute an operation, such as data storage, indicated by an instruction to the memory device. Accordingly, even though a digital device to be used is changed from one kind of digital device to another kind, a simple change of a sequence of instructions to be executed can easily generate an appropriate signal pattern. Hence, even though the kind of a digital device to be used is changed to another kind, the interface can be controlled easily.

Specifically, the integrated circuit causes the functional block to generate a control signal controlling an interface through execution of a predetermined instruction code by, for example, firmware. Hence, when new interface control is desired, only approaches required to the use of the new interface are, for example, to (i) change the firmware to be stored in the integrated circuit in order to change a kind of instruction code which generates a control signal, and (ii) change the timing of executing the instruction code to generate the control signal. In other words, the integrated circuit can easily carry out interface control using a new interface type only with the above approaches. The above feature eliminates the need for the integrated circuit re-designing which requires an excessive developing period.

It is noted that, in the integrated circuit, the following may be possible: an instruction code to be stored in the integrated circuit is executed, the instruction code to be stored is rewritable, and an interface can be controlled employing a new interface type thanks to the rewriting of the instruction code.

The integrated circuit according to the aspect of the present invention may further include an input and output path changing unit which (i) changes an input and output path of data in the functional block when the microprocessor executes the predetermined instruction code, and (ii) provides the generated control signal to the memory device through the changed input and output path. This structure allows the input and output path to be changed. Accordingly, the control signal to be provided can be sufficiently and freely changed.

In the integrated circuit according to the aspect of the present invention, the functional block may hold data indicating the control signal, and generate a control signal indicated by the held data, the predetermined instruction code may include the held data indicating the control signal, and the microprocessor may cause the functional block to hold the data included in the predetermined instruction code so as to cause the functional block to generate the control signal indicated by the held data.

The integrated circuit can easily generate an appropriate control signal through a simple change of data included in a predetermined instruction code, and execute a new interface control.

In the integrated circuit according the aspect of the present invention, the predetermined instruction code may include register specifying data specifying a register in which data indicating the control signal is stored, and the functional block may obtain the data stored in the register specified by the register specifying data included in the predetermined instruction code, and generate the control signal indicated by the obtained data.

The integrated circuit can easily generate various control signals. Accordingly, the integrated circuit can easily control various new interfaces.

In the integrated circuit according to the aspect of the present invention, the data stored in the register may be changed by the microprocessor, and when the microprocessor changes the data stored in the register, the functional block may change a control signal to be generated from a control signal indicated by data before the change to a control signal indicated by data after the change.

The integrated circuit can easily and freely change a control signal to be generated using an instruction code which changes register data, instead of using the above described predetermined instruction code. Accordingly, the integrated circuit can easily and freely control a new interface.

The integrated circuit according to the aspect of the present invention may further include: a second functional block which generates a second control signal which (i) is predetermined and (ii) executes interface control of the memory device; and a second input and output path changing unit which (i) changes an input and output path of data in the second functional block, and (ii) provides the generated second control signal to the memory device, wherein the predetermined instruction code includes block specifying data specifying one of the first functional block and the second functional block, the microprocessor causes (i) the second functional block to generate and provide the second control signal in the case where the block specifying data included in the predetermined instruction code specifies the second functional block, and (ii) the first functional block to generate and provide the first control signal in the case where the block specifying data specifies the first functional block, and the signal pattern to be generated includes a part of the first control signal and a part of the second control signal.

Hence, the integrated circuit uses both of the first and the second functional block, and can freely and easily generate various control signals. Accordingly, the integrated circuit can freely and easily control various new interfaces.

In the integrated circuit according to the aspect of the present invention, in the case where the predetermined instruction code is executed, the first functional block may (i) select, as an output signal of the interface unit, a predetermined value of an internal register included in the microprocessor, and (ii) provide the selected value as the control signal from the interface unit to the memory device.

Hence, the integrated circuit receives a change of an internal register value as a control signal, and can sufficiently and freely control the received control signal.

The integrated circuit according to the aspect of the present invention may further include a selection functional block which selects a signal to be asserted from among predetermined signals, wherein, when an instruction code to be executed is the predetermined instruction code, the microprocessor may (i) suspend execution of the instruction code, and (ii) execute the predetermined instruction code once all the predetermined signals are asserted.

Hence, the integrated circuit can generate a control signal at an appropriate time after signals to be asserted are all asserted. Accordingly, the integrated circuit can easily generate a control signal at the appropriate time.

It is noted that in the present invention, a microprocessor has an instruction code including (i) configuration address information which is used for a circuit configuration and (ii) data to be written to the address. Then, the present invention employs a structure to physically connect small functional blocks re-configurable by an instruction code. Thanks to this structure, a combination of instruction codes allows the circuit configuration to be dynamically changed to any given circuit configuration. Accordingly, a memory interface circuit can be freely configured. Hence, a change of firmware for a built-in microprocessor allows one control LSI to interface with various external memory devices, such as a flash memory and a secure digital (SD) card. In the case of controlling a device which will possibly be changed in specifications near future, the above feature makes possible providing an ASIC which flexibly copes with a change of a memory I/F protocol in the future.

In addition, the present invention is for example a memory interface circuit system using an instruction code so as to dynamically reconfigure a circuit. In order to change specifications of an interface circuit to an external memory after completing the development of an ASIC, the circuit needs re-designing, resulting in prohibitive development costs. The present invention eliminates the need for the re-designing and the prohibitive development costs.

### Advantageous Effects of Invention

The present invention can provide easy interface control employing a new interface type.

### BRIEF DESCRIPTION OF DRAWINGS

FIG. 1 is a block diagram of an ASIC according to Embodiment 1 in the present invention.

FIG. 2 shows an instruction code executing a configuration according to Embodiment 1 in the present invention.

FIG. 3 is a timing diagram showing a command transmission operation according to Embodiment 1 in the present invention.

FIG. 4 shows an instruction code used for executing a configuration according to Embodiment 2 in the present invention.

FIG. 5 is a block diagram of an ASIC according to Embodiment 3 in the present invention.

FIG. 6 is a timing diagram showing a command transmission operation according to Embodiment 3 in the present invention.

FIG. 7 is a block diagram of an ASIC according to Embodiment 4 in the present invention.

FIG. 8 exemplifies a logic circuit of a functional unit according to Embodiment 4 in the present invention.

FIG. 9 is a timing diagram of a direct memory access (DMA) operation according to Embodiment 4 in the present invention.

FIG. 10 shows a data origin, the ASIC, and an external memory.

### DESCRIPTION OF EMBODIMENTS

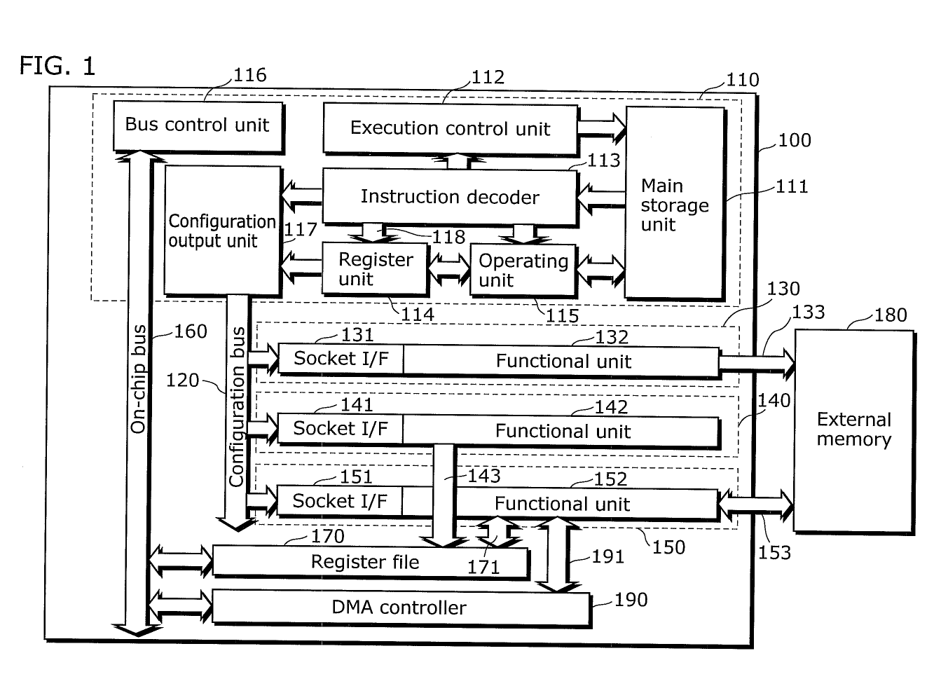

Hereinafter, Embodiments of the present invention shall be described with reference to FIGS. 1 to 10.

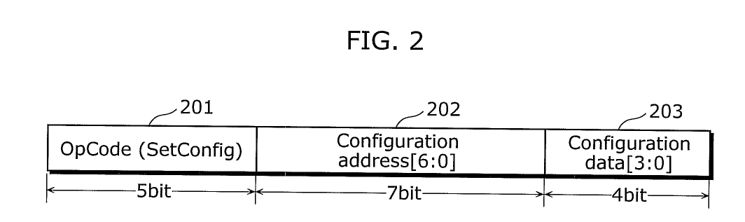

Embodiments exemplify integrated circuits below. One of the integrated circuit (an ASIC 100) includes a microprocessor (a microprocessor 110). The microprocessor executes a predetermined instruction code (an instruction code for a configuration. See FIG. 2), and includes a storage unit and an instruction decoder. The integrated circuit includes the following: an interface unit (a signal line for signals such as an external output signal 153 and external output signal 133) through which data is transmitted between a memory device which stores digital data and the integrated circuit, a functional block (a functional block 130, a functional block 140, and a functional block 150) which generates, through an operation reconfiguration, a predetermined control signal executing interface control of the memory device, the operation reconfiguration being carried out by (i) the microprocessor executing the predetermined instruction code, and (ii) the instruction decoder decoding the predetermined instruction code, and an input and output path changing unit (a functional block including all of the functional block 130, a functional block 140, and a functional block 150) which (i) changes an input and output path of data in the functional block when the microprocessor executes the predetermined instruction code, and (ii) provides the generated control signal to the memory device through the changed input and output path, wherein the functional block generates a predetermined signal pattern by the microprocessor executing a predetermined sequence of instructions (i) stored in the storage unit, and (ii) including instruction codes having the predetermined instruction code.

Accordingly, even though a digital device to be used is changed from one kind of digital device to another kind, the interface can be easily controlled by the other kind of digital device.

In other words, the control signal for controlling an interface is generated through execution of predetermined instruction code by for example firmware. The above feature eliminates the need for the integrated circuit re-designing which requires an excessive developing period even in the case where new interface control is desired. In other words, the interface can be controlled through a new interface type with, for example, a simple change of the firmware to be stored in the integrated circuit in order to change an instruction code which generates the control signal. This structure easily makes possible executing interface control using a new interface type.

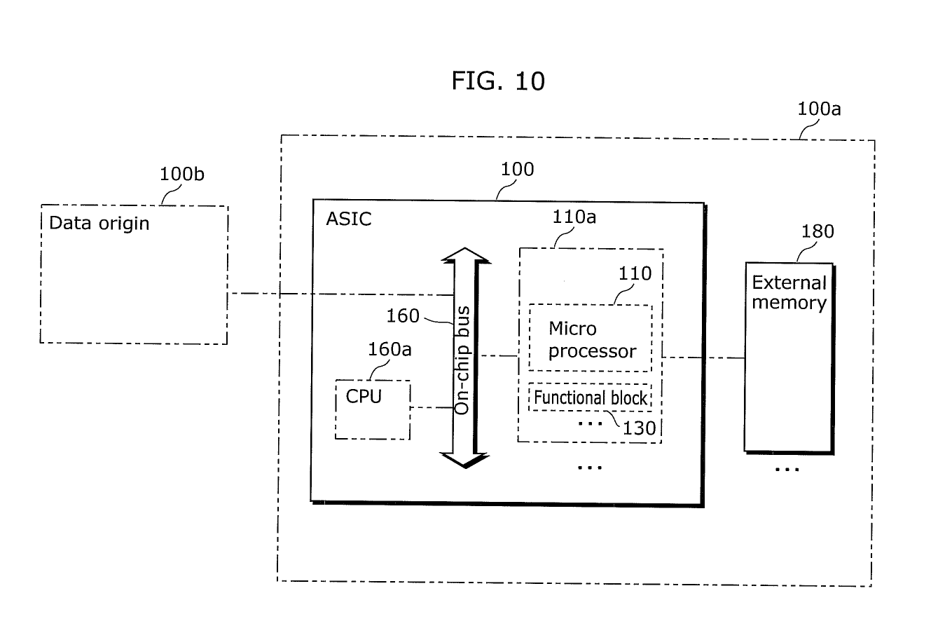

More specifically, an integrated circuit below is exemplified. The integrated circuit is an ASIC (the ASIC 100) included in a connecting unit (an overall unit 100a, a PC card (an expansion card)) to be connected to a computer (a data origin 100b and a note PC in FIG. 10), wherein the connecting unit has memory cards of a single kind from among the memory cards of two or more kinds (a Universal Serial Bus (USB) memory, a U3, an SD memory card, a mini SD card, a micro SD card, and a memory stick) equipped with flash memories, the memory device (the external memory 180) is one of the memory cards of the single kind, the integrated circuit receives from the computer an instruction which causes the memory device to execute an operation, the functional block (the functional block 130) generates from among control signals a control signal corresponding to control which the functional block receives, and provides the generated control signal to the memory device through the interface unit (the signal line of the external output signal 153), each of the control signals corresponds to one of the two or more kinds, and causes the corresponding kind of memory card to execute an operation of the received instruction, the microprocessor (the microprocessor 110) executes a sequence of instructions from among sequences of instructions, each of the sequences of instructions corresponds to the one of the two or more kinds, and causes the microprocessor to execute control on the functional block so that the functional block generates the control signal provided to the corresponding kind of memory card, the sequence of instructions executed by the microprocessor is a sequence of instructions of the one of the memory cards of the single kind, and the signal pattern is a signal pattern of the control signal to be generated through the execution of the sequence of instructions.

It is noted that the numerical reference “153” may be understood as a signal line for an external output signal instead of an external output signal itself. The interface unit may for example connect only to the one kind of memory device from among the two or more kinds memory devices. Furthermore, the interface unit may be connected to another kind of memory device after a prospective design change. The microprocessor may store only the sequence of instructions, from among sequences of instructions, corresponding to the one kind of memory device. Then, the microprocessor may store another kind of sequence of instructions after a prospective design change.

### EMBODIMENT 1

FIG. 1 exemplifies a circuit configuration of an ASIC 100, according to Embodiment 1 in the present invention, including an interface used for receiving and providing digital data stored in a flash memory.

The ASIC 100 includes a microprocessor 110, a functional block 130, a functional block 140, a functional block 150, a register file 170, a DMA controller 190, an on-chip device 160, and a configuration bus 120.

The microprocessor 110 is a micro processor according to Embodiments in the present invention. FIG. 1 shows an internal structure of the microprocessor 110.

The microprocessor 110 also includes a main storage unit 111, an execution control unit 112, an instruction decoder 113, a register unit 114, an operating unit 115, a bus control unit 116, and a configuration output unit 117.

The main storage unit 111 is a memory storing the following: a program area in which instruction codes are stored, a data area in which working data is stored, and a stack area in which data is temporarily stored. Here, some of the instruction codes are instruction codes for configuration described later, and included in a program stored in the above program area by the main storage unit 111.

The execution control unit 112 is a control circuit for controlling: execution of a program such as a program counter, a memory management unit (MMU), conditional branching, and interrupt control.

According to an instruction code read from the main storage unit 111, the instruction decoder 113 generates a control signal used for controlling another unit.

The register unit 114 includes a register in which operation data and address information are temporarily stored.

The operating unit 115 performs an operation on the data stored in the register and the main storage 111 and stores the operation result in the register and the main storage unit 111.

The bus control unit 116 inputs and outputs data between the microprocessor 110 and another module included in the ASIC 100 via the on-chip bus 160 included in the ASIC 100.

It is noted that, in order to specify a circuit system, the instruction code of the microprocessor 110 according to Embodiments is 16-bit wide for the sake of convenience; concurrently, another word length, such as 32-bit width, may also be applied.

FIG. 2 specifically exemplifies an instruction code for configuration configuring the functional block 130 described in Embodiment 1.

The instruction code for configuration shown in FIG. 2 includes an identifier 201, a configuration address 202, and configuration data 203.

The identifier 201 is an identifier (hereinafter referred to as SetConfig) identifying an instruction code. It is noted that the identifier 201 is a value which differs from a value of an identifier of any other instruction code than the instruction code for configuration.

Here, the instruction decoder 113 tells the instruction code for configuration shown in FIG. 2 from another instruction code, using the identifier 201 included in the instruction code for configuration.

When the instruction code for configuration is identified, the configuration output unit 117 holds the configuration address 202 and the configuration data 203 that are included in the instruction code. Then the configuration output unit 117 outputs to the configuration bus 120 a signal including ConfigWrite signal indicating a configuration time, ConfigAddr [6:0], and ConfigData [3:0].

Next, the functional block 130 exemplified in Embodiment 1 includes a functional unit 132 which has a socket I/F 131 (where ConfigAddr=00h) and four flip-flops. It is noted that an external output signal 133 provided from the functional block 130 is an output signal from the four flip-flops.

In Embodiment 1, it is noted that an external memory (flash memory) 180 is described as a typical NAND-type flash memory for the convenience of explanation; concurrently, this shall not limit a kind of a flash memory and a type of interface as a matter of course.

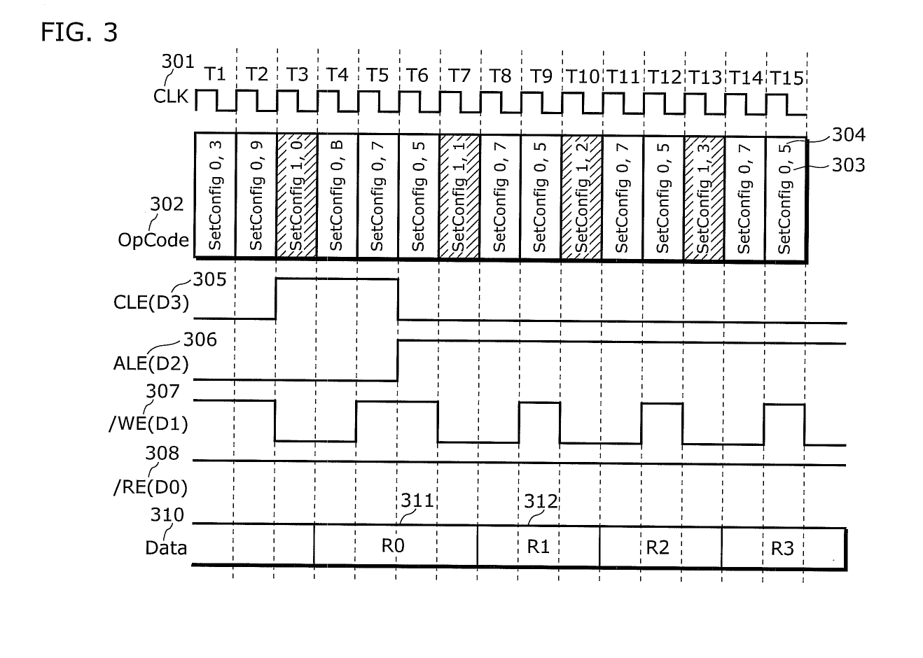

FIG. 3 is a timing diagram showing a command transmission operation.

A clock signal 301 is supplied to the microprocessor 110.

OpCode 302 is an instruction code read from the main storage unit 111. Regarding the two numbers following the instruction code, the first number which a numerical reference 303 denotes is the configuration address 202 (See FIG. 2) included in the instruction code for configuration. The next number which a numerical reference 304 denotes is the configuration data 203 (See FIG. 2) included in the instruction code for configuration.

CLE 305, ALE 306, /WE 307, and /RE308 (FIG. 3) are control signals for the external memory (flash memory) 180 described in Embodiment 1. Each of the control signals corresponds to output data, shown as the external output signal 133 (FIG. 1), of four flip-flops D3 to D0 of the functional unit 132 included in the functional block 130.

Described next is the changes of the four control signals CLE 305, ALE 306, /WE 307, and /RE308 when each instruction code shown in FIG. 3 is executed at each time found on the horizontal axis in FIG. 3.

At Time T1, the microprocessor 110 executes “SetConfig 0,3” as shown in FIG. 3. Here, the operation code of the executed instruction code “SetConfig” is the identifier of the instruction code for configuration described above. The configuration address 202 (FIG. 2) of the instruction code is “0”, and the configuration data 203 (FIG. 2) is “3”. The configuration address “0” represents the address indicating the functional block 130. On the other hand, the configuration data “3” is expressed in the binary notation as follows: 3=1×1+2×1+4×0+8×0=1100.

At the rising edge at T2 of CLK 301, ConfigData [3:0] of the configuration bus 120 (See FIG. 1) outputted from the configuration output unit 117 is latched by the flip-flops D3 to D0 included in the functional block 130. Hence, at the rising edge at T2, the for control signals of the functional block 130; namely, CLE 305, ALE 306, /WE307, and /RE308 respectively correspond to 1, 1, 0, and 0 of the binary notation 1100 obtained as the result of the above calculation. In other words, each of the four flip-flop stores 1, 1, 0, and 0, respectively.

Next, at the rising edge at T3 of CLK 301, ConfigData [3:0] of the configuration bus 120 outputted by the configuration output unit 117 is latched by the flip-flops D3 to D0. The latching causes CLE 305 to change from “0” to “1”, and /WE307 to change from “1” to “0” (See FIG. 3).This is because the configuration data, of the instruction code to be executed, at T2 is 9 =1×1+2×0+4×0+8×1 which is 1001 in the binary notation.

At the rising edge at T4 of CLK 301, the configuration address 202 is 01h. Thus, the configuration address does not correspond to the functional block 130, in the socket I/F 131, included in the functional unit 132. Accordingly, the state of the flip-flops in the functional unit 132 does not change.

At the rising edge at T5 of CLK 301, /WE 307 changes from “0” to “1”. Subsequently, combinations of instruction codes make possible generating desired timing signals.

Next, the functional block 140 in Embodiment 1 (FIG. 1) shall be described.

Similar to the above described functional unit 132, a functional unit 142 included in the functional block 140 has four flip-flops. Here, an output signal 143 of each flip-flop is provided to the register file 170 as an address signal used for selecting a register of the register file 170.

It is noted that the register file 170 includes 16 8-bit registers. The register file 170 selects a register value, using the output signals (address signal) 143 for four bits. The data of the register of the selected register value is provided to the functional block 150 as an output signal 171 of the register file.

In the case of ConfigAddr (the configuration address 202 in FIG. 2)=01H, a socket I/F 141 which is structured similar to the socket I/F 131 sets Config Data (the configuration data 203 in FIG. 2) for the flip-flops included in a functional unit 152.

The functional block 150 includes the functional unit 152 which is a multiplexer generating the external output signals 153 for eight bits. According to a selecting state set by the socket I/F 151, the functional block 150 selects one of an output signal 171 of the register file 170 and an output signal 191 of the DMA controller 190 to be described hereinafter.

Here, described again is the operation performed at the rising edge at T4 of CLK 301 in the timing diagram showing a command transmission operation. At T4, ConfigAddr=01h holds. Thus ConfigData [3:0] is written to the functional block 140. This operation causes the output signal (address signal) 143 to be set to “0h”, so that a register value of the address 0 in the register file 170 is provided to the output signal 171. Here, in the case where the functional block 150 is set so that the register value (the output signal 171); that is an input signal from the register file 170, is provided to the external output signal 153 of the functional block 150, the output signal 171 is provided as the external output signal 153. Accordingly, Data 310 (See FIG. 3) of the external memory (the external flash memory) 180 becomes R0 (the numerical reference 311 in FIG. 3).

Similarly, the address value of Address 1 of the register file 170 can be provided to the external output signal 153 at the rising edge at T8 of the CLK 301.

This integrated circuit includes an input and output path changing unit which executes the instruction code to change an input and output path of data in the functional block, and to provide to the memory device the control signal generated in the changed input and output path.

In the integrated circuit, (i) the functional block 130 holds data indicating the control signal in a flip-flop, and generates a control signal indicated by the held data, (ii) the predetermined instruction code includes data (the configuration data 203 in FIG. 2) indicating the control signal, and (iii) the microprocessor causes the functional block 130 to hold the data included in the predetermined instruction code, and to generate the control signal indicated by the held data.

Hence, the integrated circuit can easily generate an appropriate control signal by simply changing data included in an instruction code, without various kinds of instruction codes for generating the control signal. Accordingly, the integrated circuit can easily control a new interface.

In the integrated circuit, (i) the predetermined instruction code includes register specifying data (the configuration data 203 in FIG. 2) specifying a register (a register of the register file 170) storing data indicating the control signal, and (ii) the functional block (a functional block including both of the functional block 140 and the functional block 150) obtains data of the register specified by the register specifying data. The integrated circuit generates a control signal indicated by the data to be obtained.

This structure allows the integrated circuit to easily generate various kinds of control signal by changing data of the register.

Through (i) a change of stored data in the register by the microprocessor, and (ii) a change of the register data in the functional block (the functional block including both of the functional block 140 and the functional block 150) by the microprocessor, the integrated circuit changes a control signal to be generated from a control signal indicated by the data before the change to a control signal indicated by the data after the change.

Thus, the integrated circuit can easily and freely change a control signal to be generated using an instruction code which changes register data, instead of the above described predetermined instruction code. Accordingly, the integrated circuit can easily and freely control a new interface.

The integrated circuit further includes (i) a second functional block (the functional block 130) which generates a predetermined second control signal controlling an interface of the memory device, and (ii) a second input and output path changing unit (functional block 130) which changes an input and output path of data in the second functional block and provides the generated second control signal to the memory device. Here, the predetermined instruction code includes block specifying data (the configuration address 202 in FIG. 2) specifying one of the first functional block and the second functional block. In the case where the block specifying data included in the predetermined instruction code specifies the second functional block, the microprocessor causes the second functional block to generate the second control signal, and to provide the second control signal to the memory device. In the case where the block specifying data specifies the first functional block, the microprocessor causes the first functional block to generate the first control signal, and to provide the first control signal to the memory device. A pattern of the signal to be generated includes a part of the first control signal and a part of the second control signal.

Hence, the integrated circuit uses both of the first and the second functional block, and can freely and easily generate various control signals. Accordingly, the integrated circuit can freely and easily control various new interfaces.

It is noted that the integrated circuit has the following feature: in the case where the predetermined instruction code is executed, the functional block (the functional block including both of the functional block 140 and the functional block 150, that is, the functional block 130) selects, as an output signal of the interface, a predetermined value of an internal register included in the microprocessor, and provides the selected value as the control signal from the interface to the memory device.

### EMBODIMENT 2

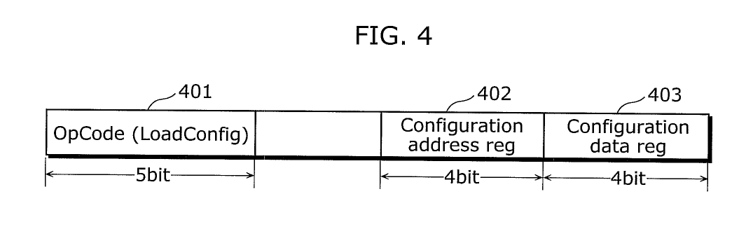

FIG. 4 exemplifies a definition of an instruction code which differs from that of the instruction code shown in FIG. 2.

The instruction code shown in FIG. 4 includes an identifier 401, data 402, and data 403.

The identifier 401 is an identifier (hereinafter referred to as LoadConfig) for identifying an instruction code. According to the identifier 401, the instruction decoder 113 identifies the instruction code. The data 402 has information assigned for selecting an internal register, of the register unit 114, holding a configuration address. Similarly, the data 403 has information assigned for selecting an internal register, of the register unit 114, holding configuration data. The use of each piece of information of four bits allows, via a signal 118 (FIG. 1), to select up to 16 internal register included in the register unit 114. Here, in the case where the internal register is 16 bits as so in Embodiment 1, the instruction code having LoadConifg makes possible setting a functional block to be connected to the configuration bus 120 including up to ConfigAddr [15:0] and ConfigData [15:0].

Thus, the integrated circuit is structured as follows: the predetermined instruction code (the instruction code for configuration) includes register specifying data (the data 403 in FIG. 4) specifying a register (an internal register of the register unit 114) in which data indicating a control signal is stored; and the functional block (the functional block 130) (i) obtains the data of the register specified by the register specifying data included in the predetermined instruction code, and (ii) generates the control signal indicated by the obtained data.

### EMBODIMENT 3

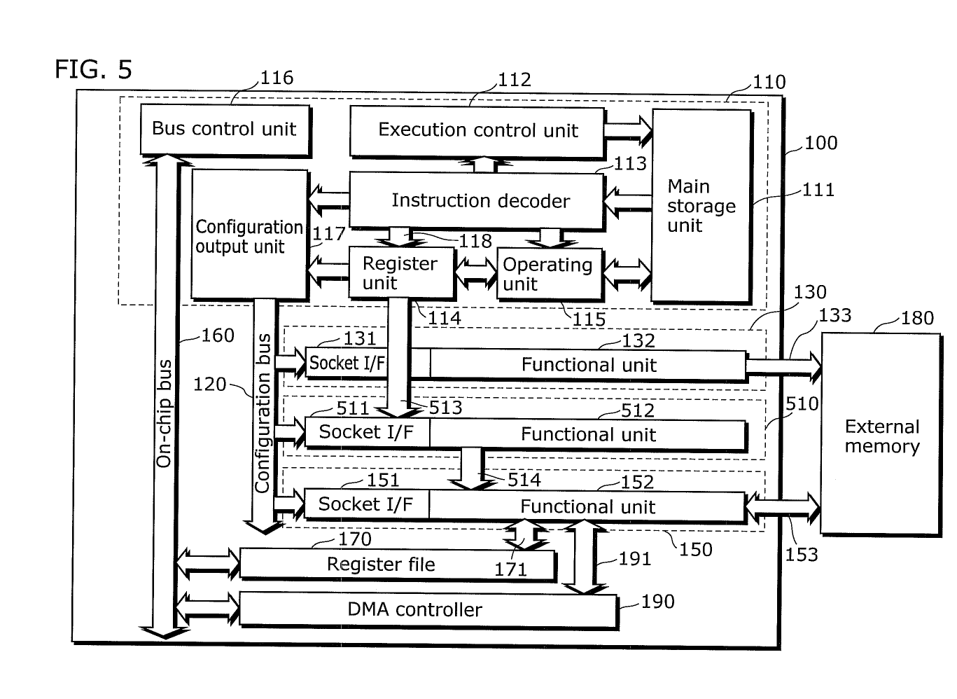

FIG. 5 shows an embodiment with an expanded external interface circuit system controlled by a program. The expansion involves adding to the structure described in Embodiment 1 a functional block 510 which selects and provides a value of an internal register of the register unit 114.

It is noted that FIG. 5 has the illustration of the functional block 140 (See FIG. 1) omitted due to illustrating reasons.

According to output states of four flip-flops to be set via the a socket I/F 511, a functional unit 512 selects one of 16 internal registers (R0 to R15) in an internal register output 513 included in the register unit 114, and provides to the functional block the selected internal register as an output signal 514.

As shown in Embodiment 1, the functional block 150 includes the functional unit 152; namely a multiplexer, which (i) selects the output signal 514 of the functional unit 512 based on the selecting state set by the socket I/F 151, and (ii) generates the external output signals 153 for eight bits.

As described before, the instruction code SetConfig sets the configurations of the functional blocks 510 and 150 via the configuration bus 120. Furthermore, the external output signal 153 of the functional block 150 is set so that an internal register (assume R0) of the register unit 114 is provided. This setting allows an internal register value of the register unit 114 to be provided as an external output signal.

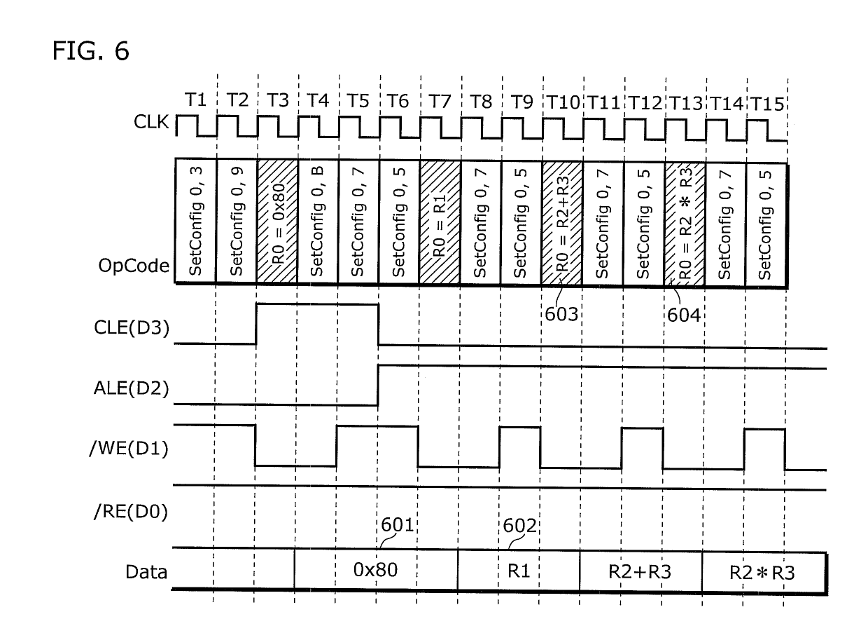

FIG. 6 is a timing diagram showing a command transmission operation according to Embodiment 3.

Hereinafter, a command transmission operation is described again with reference to a timing diagram shown in FIG. 6. The operations other than those of the shaded instructions are the same as the operations described in FIG. 3, and thus the details shall be omitted. An instruction code (Load) issued at T3 changes a state of the internal register R0 to a state 601 of “0×80” at the rising edge at T4 of CLK. The functional block 150 provides the “0×80” as the external output signal 153.

Similarly given hereinafter, in a state 602 at the rising edge at T8 of CLK, R0=R1 (Copy) is held. Thus, a register of R1 is provided.

Furthermore, similarly given hereinafter, the operating unit 115 in the microprocessor 110 is effectively used to execute operation, so that a desired interface circuit operation can be introduced, instead of an operation instruction (603 and 604) of the operating unit 115 executing an input and output operation via the register file 170 using the on-chip bus 160 described in Embodiment 1.

In FIG. 6, specifically, when an instruction code of “R0=R2+R3” indicated at T10 is executed by the microprocessor 110 (FIG. 5), an operation result of R2+R3; namely the operation result R2+R3, is written to and held in the internal register R0 of the register unit 114. Then, the held operation result R2+R3 is provided as the output signal 514 by the functional block 510, and then provided as the external output signal 153 by the functional block 150.

Similarly, according to an instruction code “R0=R2*R3” at T13, the operating result R2*R3 executed by the instruction code at T13 is provided as the external output signal 153 at T14.

Hence, the integrated circuit is structured as follows: the instruction code for configuration includes a register specifying data (configuration data) specifying a register (the internal register of the register unit 114) in which data indicating a control signal is stored; and the functional blocks (the functional blocks 510 and 150) obtains the data of the register specified by the register specifying data included in the instruction code, and generates the control signal indicated by the obtained data.

Through (i) a change of stored data in the register by the microprocessor (see the substitution of “R0=0×80” shown in FIG. 6), and (ii) a change of the register data in the functional block by the microprocessor, the integrated circuit changes (see T3 to T4, T7 to T8, and T13 to T14 in FIG. 6) a control signal to be generated from a control signal indicated by the data before the change to a control signal indicated by the data after the change.

### EMBODIMENT 4

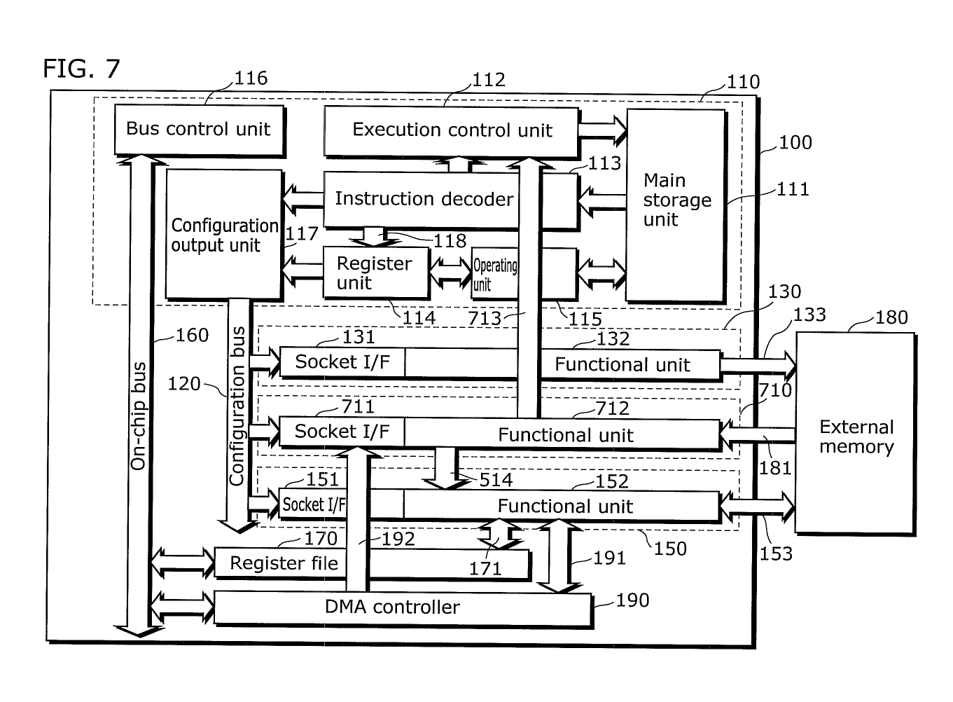

Next, Embodiment 4, which puts the present invention into effect, is described with reference to FIGS. 7 to 9. Embodiment 4 involves controlling, on the structure described in Embodiment 1, an execution state of an instruction code of a microprocessor, depending on a state of an internal signal.

FIG. 7 is a block diagram of an ASIC according to Embodiment 4.

A functional block 710 uses the functional unit 712 to generate an OpReady signal 713 controlling execution of a state machine for controlling execution of an instruction in the execution control unit 112. In the generating, the functional unit 712 uses signals indicating a state of the circuit and an Enable signal 801. The signals indicating the circuit state include, for example, a DataReady signal 192 indicating whether or not data for reading the output signal 191 from the DMA controller 190 is left, and a Busy signal 181 for determining whether or not the external memory 180 can move to the next operational state upon receiving a command. It is noted that the signals indicating the circuit state are described as the DataReady signal 192 and the Busy signal 181 for simplicity. Moreover, the Enable signal 801 (“1” is valid) is a signal (“1” is valid) set via a socket I/F 711 and indicating whether a signal indicating the circuit state is valid or invalid.

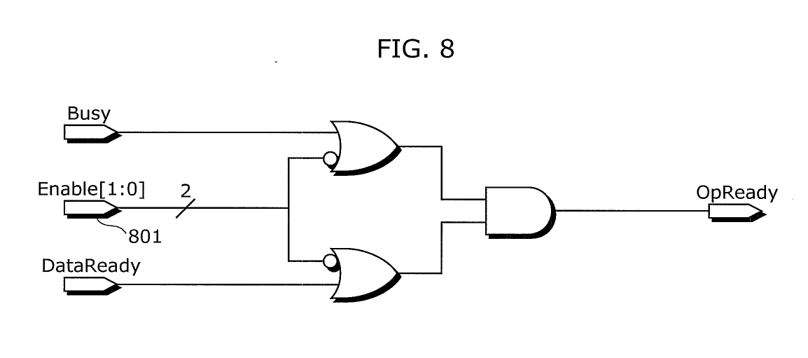

FIG. 8 exemplifies a logic circuit of the functional unit 712.

In other words, when Enable [1:0]=“01” is set, the state of the OpReady signal 713 can be equally set to that of the DataReady signal 192.

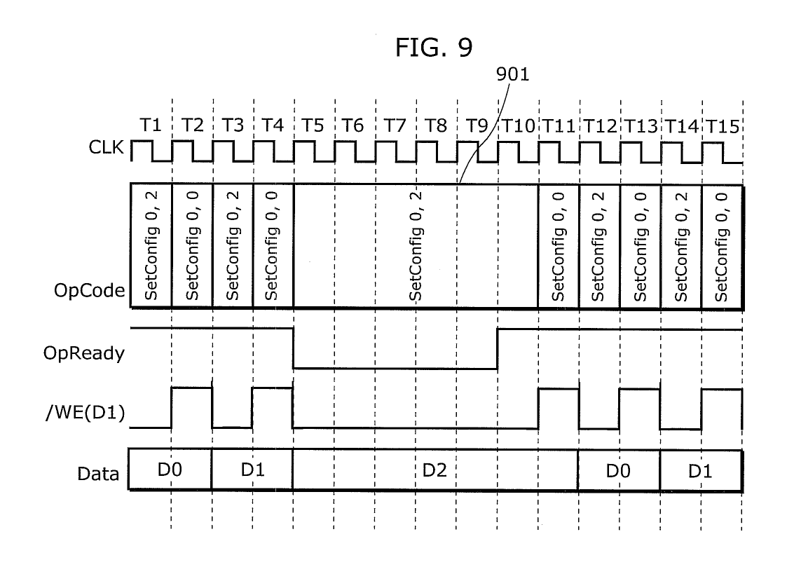

FIG. 9 is a timing diagram showing a command transmission operation according to Embodiment 4. Next, the control operation in Embodiment 4 shall be described with reference to FIG. 9.

The operations performed until the rising edge at T5 of CLK are similar to those described in Embodiment 1. Concurrently, at the rising edge at T6 of CLK, the OpReady signal 713 is “0”. Thus, the microprocessor 110 suspends execution of an instruction code “SetConfig 0,2” indicated in a numerical reference 901. Then, at the rising edge at T11 of CLK, the DataReady signal 192 of the DMA controller 190 is asserted. Asserting the DataReady signal 192 can assert the OpReady signal 713, the execution of the instruction code in the execution control unit 112 can be resumed, and the data transfer operation can continue.

Thus, the integrated circuit further includes the following features: a selection functional block (the functional block 710) selects a signal which is to be asserted from among predetermined signals (the DataReady signal 192 and the Busy signal 181); and when an instruction code to be executed is the predetermined instruction code (an instruction code for configuration), the microprocessor (i) suspends execution of the instruction code to be executed until all the signals to be selected by the selection functional block are asserted (see T6 to T10 in FIG. 9), and (ii) executes the predetermined instruction code (see T11 in FIG. 9) once all the signals to be selected are asserted.

The integrated circuit may use a functional block including a functional unit having its circuit configured as a P/S converter and an

S/P converter, instead of the functional blocks described in the above Embodiments. Then, the integrated circuit may have a circuit structured to physically connect a lot of functional blocks, using a selection functional block capable of multiplexing indicated in the functional block 150. This structure allows the integrated circuit to be applied to a circuit system for digital data interfaces in general, as well as to be effective as a memory interface circuit.

### EMBODIMENT 5

The present invention may include Embodiment 5 described below. Each of the above Embodiments may include a part of Embodiment 5 described below. Embodiment 5 may have a part of each Embodiment described above.

An integrated circuit (ASIC 100) is connected to the external memory (the external memory 180). The integrated circuit may include a microprocessor (the microprocessor 110) having a predetermined instruction code (an instruction code for configuration), and a first control signal generating unit (the functional block 130) which generate a predetermined control signal controlling an interface of an external memory.

Here, the above instruction code to be executed may be firmware of the integrated circuit.

Instead of a rewritable circuit such as the FPGA, the integrated circuit may be a different kind of circuit which is un-rewritable. This structure allows the integrated circuit to have benefits of the different kind of circuit, such as a lower price per device and a faster speed, as well as to easily use a new interface.

The integrated circuit may further include a data holding unit (a register of the register unit 114 and a register of the register file 170) which holds data indicating a control signal. When the instruction code is executed by the microprocessor, the first control signal generating unit may obtain the held data, and generate the control signal indicated by the obtained data. Moreover, the integrated circuit may include a second control signal generating unit generating a predetermined second control signal controlling an interface of the external memory. The instruction code includes generating unit specifying data (a configuration address) specifying one of the control signal generating units. When the instruction code is executed by the microprocessor, the first control signal generating unit may generate the first control signal only in the case where the one of the control signal generating units specified by the instruction code is the first control signal generating unit. When the instruction code is executed by the microprocessor, the second control signal generating unit may generate the second control signal only in the case where the one of the control signal generating units specified by the instruction code is the second control signal generating unit.

The integrated circuit according to Embodiment 5 is the same as that according to any given Embodiment except for the points described above. In other words, the integrated circuit according to the other Embodiment may be the same as that according to any one of Embodiment 1, Embodiment 2, Embodiment 3, and Embodiment 4, except for the points described above.

The details of each Embodiment, such as Embodiment 1, may be for example described as below. It is noted that the description below is merely an example.

FIG. 10 exemplifies a data origin 100b having the ASIC 100 connected.

The data origin 100b is, for example, a note PC and a predetermined storage area, and provides data to be stored in the external memory 180. It is noted that the data origin 100b may obtain the data stored in the external memory 180 from the external memory 180. It is also noted that the data origin 100b may generate an instruction to be used for operating the external memory 180, and provide the generated instruction to the ASIC 100.

In a relaying unit 110a, the functional block 130 executes an operation controlled by the microprocessor 110 to generate the control signal provided to the external memory 180. This operation causes the generated control signal to be provided to the external memory 180, and the data provided from the data origin 100b is relayed to the external memory 180 by the relaying unit 110a. It is noted, for example, that the relaying unit 110a may relay the data provided from the external memory 180 to the data origin 100b. For example, the ASIC 100 may be equipped with a CPU 160a controlling a data flow between the data origin 100b and the relaying unit 110.

To be more specific, the microprocessor 110 and the functional block 130 generate a control signal to be specified by the instruction generated by the data origin 100b to relay the data.

It is noted that an overall unit 100a including the ASIC 100 and the external memory 180 may be, for example, a PC card or another expansion card to be inserted into the data origin 100b, such as a note PC. The overall unit 100a may also include several pairs of the above relaying unit 110a and the external memory 180.

As described above, the integrated circuit is an ASIC (the ASIC 100) receiving (i) an instruction to cause the memory device to execute an operation for storing data generated by the data origin (the data origin 100b), and (ii) the data. The signal pattern to be generated causes the memory device to execute the operation for storing the received data.

Moreover, the details of Embodiment 1 may be the ones described below. It is noted that the description below is a mere example.

The integrated circuit (the ASIC 100) includes an interface unit (a signal line for the external output signal 153), a functional block (the functional blocks 130 to 150), and a microprocessor (the microprocessor 110).

The interface unit provides a control signal to a one kind of memory device (the external memory 180). Here, the one kind means a one kind of memory device from among several kinds of memory devices. It is noted that the interface unit may be connected only to the one kind of memory device from among the several kinds of memory devices, and provide the control signal only to the one kind of memory device. It is noted that the interface unit may be connected to another kind of memory device after a prospective design change.

The functional block generates a control signal, and causes the interface unit to provide the generated control signal. Here, the generated control signal is a control signal, from among control signals, which responds to the control that the functional block receives. Here, each of the control signals corresponds to an associated one of the several kinds of memory devices. Each of the control signals causes an associated one of the kinds of memory devices to execute an operation indicated by an instruction.

The microprocessor executes a sequence of instructions, from among sequences of instructions, corresponding to the control signal provided to the one kind of memory device. Here, each sequence of instructions from among the sequences of instructions corresponds to an associated one kind of memory devices. In other words, each sequence of instructions is a sequence of instructions to cause the microprocessor to execute control on the functional block so that the functional block generates a control signal corresponding to an associated one of the kinds of memory devices. It is noted that the microprocessor may store only the sequence of instructions, from among sequences of instructions, corresponding to the one kind of memory device. Then, the microprocessor may store another kind of sequence of instructions after a prospective design change.

This structure solves a problem in the following case: when another kind of memory device is used, such as the case where a memory device to be connected to the interface unit is changed from the one kind of memory device to another kind of memory device due to a prospective design change. In other words, an appropriate operation is easily executed once the microprocessor simply executes a sequence of instructions corresponding to another kind of memory device. This structure makes possible easily and appropriately controlling an interface even though the kind of a memory device is changed.

It is noted that the control signal includes, for example, some or all of control signals included in a signal pattern causing the one kind of memory device to execute the operation indicated by the instruction.

Although only some exemplary Embodiments of this invention have been described in detail above, those skilled in the art will readily appreciate that many modifications are possible in the exemplary Embodiments without materially departing from the novel teachings and advantages of this invention. Accordingly, all such modifications are intended to be included within the scope of this invention.

### INDUSTRIAL APPLICABILITY

A microprocessor-type memory interface circuit system in an implementation of the present invention is significantly effective since the system makes possible changing the specifications of the interface circuit configuration through, for example, a firmware change. In particular the microprocessor-type memory interface circuit system is highly useful as an ASIC circuit system.

### REFERENCE SIGNS LIST

100 ASIC

100a Overall unit

100b Data origin

110 Microprocessor

110a Relaying unit

111 Main storage unit

112 Execution control unit

113 Instruction decoder

114 Register unit 114

115 Operating unit

116 Bus control unit

117 Configuration output unit

118 Signal

120 Configuration bus

130, 140, 150, 510, and 710 Functional block

131, 141, 151, 511, and 711 Socket I/F

132, 142, 152, and 712 Functional unit

133 and 153 External output signal

143, 171, 191, and 514 Output signal

160 On-chip bus

160a CPU

170 Register file

180 External memory

190 DMA controller

192 DataReady signal

1. An integrated circuit comprising:
a microprocessor which executes a predetermined instruction code and includes a storage unit and an instruction decoder;
an interface unit through which data is transmitted between a memory device which stores digital data and said integrated circuit; and
a functional block which generates, through an operation reconfiguration, a predetermined control signal executing interface control of the memory device, the operation reconfiguration being carried out by (i) said microprocessor executing the predetermined instruction code, and (ii) the instruction decoder decoding the predetermined instruction code,
wherein said functional block generates a predetermined signal pattern by said microprocessor executing a predetermined sequence of instructions (i) stored in the storage unit, and (ii) including instruction codes having the predetermined instruction code.

2. The integrated circuit according to claim 1, further comprising
an input and output path changing unit configured to (i) change an input and output path of data in said functional block when said microprocessor executes the predetermined instruction code, and (ii) provide the generated control signal to the memory device through the changed input and output path.

3. The integrated circuit according to claim 1,
wherein said functional block holds data indicating the control signal, and generates a control signal indicated by the held data,
the predetermined instruction code includes the held data indicating the control signal, and
said microprocessor causes said functional block to hold the data included in the predetermined instruction code so as to cause said functional block to generate the control signal indicated by the held data.

4. The integrated circuit according to claim 1,
wherein the predetermined instruction code includes register specifying data specifying a register in which data indicating the control signal is stored, and
said functional block obtains the data stored in the register specified by the register specifying data included in the predetermined instruction code, and generates the control signal indicated by the obtained data.

5. The integrated circuit according to claim 4,
wherein the data stored in the register is changed by said microprocessor, and
when said microprocessor changes the data stored in the register, said functional block changes a control signal to be generated from a control signal indicated by data before the change to a control signal indicated by data after the change.

6. The integrated circuit according to claim 5, further comprising:
a second functional block which generates a second control signal which (i) is predetermined and (ii) executes interface control of the memory device; and
a second input and output path changing unit configured to (i) change an input and output path of data in said second functional block, and (ii) provide the generated second control signal to the memory device
wherein the predetermined instruction code includes block specifying data specifying one of said first functional block and the second functional block,
said microprocessor causes (i) said second functional block to generate and provide the second control signal in the case where the block specifying data included in the predetermined instruction code specifies said second functional block, and (ii) said first functional block to generate and provide the first control signal in the case where the block specifying data specifies said first functional block, and the signal pattern to be generated includes a part which is the first control signal and a part which is the second control signal.

7. The integrated circuit according to claim 6,
wherein in the case where the predetermined instruction code is executed, said first functional block (i) selects, as an output signal of said interface unit, a value of an predetermined internal register included in said microprocessor, and (ii) provides the selected value as the control signal from said interface unit to the memory device.

8. The integrated circuit according to claim 1, further comprising
a selection functional block which selects a signal to be asserted from among predetermined signals,
wherein, when an instruction code to be executed is the predetermined instruction code, said microprocessor (i) suspends execution of the instruction code, and (ii) executes the predetermined instruction code once all the predetermined signals are asserted.

9. The integrated circuit according to claim 1,
wherein said functional block further includes:
a first functional block which stores data specifying the control signal, and provides the control signal specified by the stored data;
a second functional block whose registers each of which stores a value, and stores data specifying a register from among the registers each providing the stored value, and
a third functional block which stores data specifying one of the register and a direct memory access (DMA) controller, and provides, as the control signal, a value to be provided from one of the register and the DMA controller which is specified by the stored data.

10. The integrated circuit according to claim 9,
wherein the predetermined instruction code includes (i) a first part specifying a functional block from among said first functional block, said second functional block, and said third functional block, and (ii) a second part specifying data, and
when said microprocessor executes the predetermined instruction code, said microprocessor changes the data to be stored by the functional block to the data to be specified by the second part, the functional block being specified by the first part of the predetermined instruction code.

11. The integrated circuit according to claim 10,
wherein said integrated circuit is an application specific integrated circuit (ASIC) which receives (i) an instruction which causes the memory device to execute an operation for storing data provided from a data origin, and (ii) the data, and
the predetermined signal pattern to be generated is a signal pattern to cause the memory device to execute the operation for storing the received data.

12. The integrated circuit according to claim 2,
wherein said integrated circuit is an ASIC included in a connecting unit to be connected to a computer,
the connecting unit has memory cards of a single kind from among the memory cards of two or more kinds equipped with flash memories,
the memory device is one of the memory cards of the single kind,
said integrated circuit receives from the computer an instruction which causes the memory device to execute an operation,
said functional block generates from among control signals a control signal corresponding to control which the functional block receives, and provides the generated control signal to the memory device through said interface unit,
each of the control signals corresponds to one of the two or more kinds, and causes the corresponding kind of memory card to execute an operation of the received instruction,
said microprocessor executes a sequence of instructions from among sequences of instructions,
each of the sequences of instructions corresponds to the one of the two or more kinds, and causes said microprocessor to execute control on said functional block so that said functional block generates the control signal provided to the corresponding kind of memory card,
the sequence of instructions executed by said microprocessor is a sequence of instructions of the one of the memory cards of the single kind, and
the signal pattern is a signal pattern of the control signal to be generated through the execution of the sequence of instructions.
